(19) United States
(12) Patent Application Publication
(10) Pub. No.: US 2010/0021697 A1
(43) Pub. Date: Jan. 28, 2010

(54) PHOTONIC CRYSTALS COMPOSED OF UNCHARGED POLYMER PARTICLES

(75) Inventors: Reinhold J. Leyrer, Dannstadt-Schauernheim (DE); Wendel Wohlleben, Mannheim (DE); Stephan Altmann, Deidesheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF AKTIENGESELLSCHAFT, Ludwigshafen (DE)

(21) Appl. No.: 12/513,684

(22) PCT Filed: Nov. 5, 2007
(86) PCT No.: PCT/EP2007/061850

§ 371 Date: May 6, 2009

(30) Foreign Application Priority Data
Nov. 6, 2006 (EP) 06123516.4

(51) Int. Cl. B32B 27/32; B05D 3/10; C08F 112/08; B32B 5/16

(52) U.S. Cl. 428/192; 427/385.5; 525/333.3; 428/220; 428/402

(57) ABSTRACT

The use of polymer particles for producing photonic crystals, wherein the polymer particles have a weight-average particle size of greater than 600 nm and a content of ionic groups of less than 0.001 mol, preferably less than 0.0001 mol/1 g of polymer particles and the polymer particles form the lattice structure of the photonic crystal without being embedded into a liquid or solid matrix.

### STATE OF THE ART

The invention relates to the use of polymer particles for producing photonic crystals, wherein
the polymer particles have a weight-average particle size of greater than 600 nm and a content of ionic groups of less than 0.001 mol, preferably less than 0.0001 mol/1 g of polymer particles and
the polymer particles form the lattice structure of the photonic crystal without being embedded into a liquid or solid matrix.

The invention further relates to photonic crystals which are obtainable by this use.

A photonic crystal consists of periodically arranged dielectric structures which influence the propagation of electromagnetic waves. Compared to normal crystals, the periodic structures have such orders of magnitude that interactions with long-wavelength electromagnetic radiation occur, and optical effects in the region of UV light, visible light, IR or else microwave radiation can thus be made utilizable for technical purposes.

Synthetic polymers have already been used to produce photonic crystals. EP-A-955 323 and DE-A-102 45 848 disclose the use of emulsion polymers with a core/shell structure. The core/shell particles are filmed, the outer, soft shell forming a matrix in which the solid core is intercalated. The lattice structure is formed by the cores; after the filming, the shell serves merely to fix the structure.

Chad E. Reese and Sandford A. Asher, Journal of Colloid and Interface Science 248, 41-46 (2002) disclose the use of large, charged polymer particles for producing photonic crystals. The polymer used consists of styrene and hydroxyethyl acrylate (HEA). The potassium persulfate used as the initiator also reacts with HEA, which forms the desired ionic groups.

The preparation of large polymer particles from polymethyl methacrylate is described in EP-A-1 046 658; use for the production of photonic crystals is not mentioned.

For many applications, very large photonic crystals are desired. A prerequisite for very good optical properties is a very well-defined, i.e. substantially ideal, lattice structure over the entire photonic crystal.

It was therefore an object of the present invention to provide large photonic crystals with good optical properties.

Accordingly, the use defined at the outset has been found.

The Polymer Particles

For the inventive use, the polymer particles should have a suitable size, and all polymer particles should be substantially uniform, i.e. ideally have exactly the same size.

The particle size and the particle size distribution can be determined in a manner known per se, for example with an analytical ultracentrifuge (W. Mächtle, Makromolekulare Chemie 185 (1984) page 1025-1039), and the D10, D50 and D90 value can be taken therefrom and the polydispersity index can be determined; the values and data in the description and in the examples are based on this method.

A further method for determining the particle size and the particle size distribution is hydrodynamic fractionation (HDF).

The measurement configuration of HDF consists of a PSDA Particle Size Distribution Analyzer from Polymer Labs. The parameters are as follows: a cartridge type 2 (standard) is used. The measurement temperature is: 23.0° C., the measurement time 480 seconds; the wavelength of the UV detector is 254 nm. In this method too, the D10, D50 and D90 value are taken from the distribution curve and the polydispersity index is determined.

The D50 value of the particle size distribution corresponds to the weight-average particle size; 50% by weight of the total mass of all particles has a particle diameter less than or equal to D50.

The weight-average particle size is preferably greater than 1000 nm.

The polydispersity index is a measure of the uniformity of the polymer particles; it is calculated by the formula

P.I.=(D90−D10)/D50

in which D90, D10 and D50 denote particle diameters for which:
D90: 90% by weight of the total mass of all particles has a particle diameter of less than or equal to D90
D50: 50% by weight of the total mass of all particles has a particle diameter of less than or equal to D50
D10: 10% by weight of the total mass of all particles has a particle diameter of less than or equal to D10.

The polydispersity index is preferably less than 0.15, more preferably less than 0.10, most preferably less than 0.06.

The polymer particles are preferably those on whose surface no surface-active assistant which is used to disperse polymer particles in water is present.

In emulsion polymerization processes, the hydrophobic monomers to be polymerized are emulsified in water with the aid of a surface-active compound, for example an emulsifier or a protective colloid, and then polymerized. After the polymerization, the surface-active compound is present on the surface of the resulting polymer particles distributed in the aqueous dispersion. Even after the removal of the water and formation of a polymer film, these compounds remain as additives in the polymer and can only be removed with great difficulty.

In the polymer particles used in accordance with the invention, preferably no such surface-active assistants are present on the surface. More preferably, surface-active assistants are therefore dispensed with actually in the preparation of the polymer particles.

The polymer particles have a content of ionic groups of less than 0.001 mol, more preferably less than 0.0001 mol/1 gram of polymer.

The polymer particles should comprise a minimum level of, especially no, ionic groups.

A very low content of ionic groups, which is attributable to the use of polymerization initiators which, after the polymerization, are bonded to the ends of the polymer chains and form ionic groups, is, though, often unavoidable.

The monomers of which the polymer, i.e. the polymer particles, consist(s) are present preferably in uncharged form, i.e. without a content of salt groups, in the polymer particle.

Accordingly, in the polymerization, monomers with salt groups or monomers which easily form salt groups, for example acids, are dispensed with. Also, no reactions which lead to the formation of ionic groups are undertaken on the polymer, i.e. the polymer particles.

The polymer preferably consists to an extent of more than 90% of hydrophobic monomers which do not comprise any ionic groups, preferably nor any polar groups.

Most preferably, the polymer consists to an extent of more than 90% by weight of hydrocarbon monomers, i.e. of monomers which comprise no atoms other than carbon and hydrogen.

More preferably, the polymer consists of styrene to an extent of more than 90% by weight, more preferably to an extent of more than 95% by weight.

The polymer is, i.e. the polymer particles are, preferably at least partly crosslinked.

The polymer, i.e. the polymer particles, consist(s) of crosslinking monomers (crosslinkers) preferably to an extent of from 0.01% by weight to 10% by weight more preferably to an extent of from 0.1% by weight and 3% by weight,.

The crosslinkers are in particular monomers having at least two, preferably two, copolymerizable, ethylenically unsaturated groups. A useful example is divinylbenzene.

The polymer, i.e. the polymer particles, preferably has/have a glass transition temperature above 50° C., preferably above 80° C.

In the context of the present application, the glass transition temperature is calculated by the Fox equation from the glass transition temperature of the homopolymers of the monomers present in the copolymer and their proportion by weight:

1/Tg=xA/TgA+xB/TgB+xC/TgC
Tg: calculated glass transition temperature of the copolymer
TgA: glass transition temperature of the homopolymer of monomer A
TgB, Tg correspondingly for monomers B, C, etc.
xA: mass of monomer A/total mass of copolymer,
xB, xC correspondingly for monomers B, C etc.

The Fox equation is specified in customary textbooks, including, for example, Handbook of Polymer Science and Technology, New York, 1989 by Marcel Dekker, Inc.

### The Preparation of the Polymer

The preparation is effected preferably by emulsion polymerization.

Since the polymer particles should preferably not comprise any surface-active assistants on the surface, the preparation is more preferably effected by emulsifier-free emulsion polymerization.

In the emulsifier-free emulsion polymerization, the monomers are dispersed and stabilized in water without surface-active assistants; this is effected, in particular, by intensive stirring.

The emulsion polymerization is effected generally at from 30 to 150° C., preferably from 50 to 100° C. The polymerization medium may consist either only of water or of mixtures of water and liquids miscible with it, such as methanol. Preference is given to using only water. The feed process can be performed in a staged or gradient method. Preference is given to the feed process in which a portion of the polymerization mixture is initially charged, heated to the polymerization temperature and partly polymerized, and then the remainder of the polymerization mixture, typically via a plurality of spatially separate feeds of which one or more comprise(s) the monomers in pure form, is fed in continuously, in stages or with superimposition of a concentration gradient while maintaining the polymerization in the polymerization zone. In the polymerization, it is also possible for a polymer seed to be initially charged, for example for better setting of the particle size.

The manner in which the initiator is added to the polymerization vessel in the course of the free-radical aqueous emulsion polymerization is known to the average person skilled in the art. It can either be added completely to the polymerization vessel or used continuously or in stages according to its consumption in the course of the free-radical aqueous emulsion polymerization. Specifically, this depends upon the chemical nature of the initiator system and on the polymerization temperature. Preference is given to initially charging a portion and adding the remainder to the polymerization zone according to the consumption.

A portion of the monomers can, if desired, be initially charged in the polymerization vessel at the start of the polymerization; the remaining monomers, or all monomers when no monomers are initially charged, are added in the course of the polymerization in the feed process.

The regulator too, if it is used, can partly be initially charged, and added completely or partly during the polymerization or toward the end of the polymerization.

By virtue of the inventive emulsifier-free emulsion polymerization, stable emulsions of large polymer particles are obtainable.

Further measures which increase the mean particle diameter are known. Useful methods include, in particular, emulsifier-free salt agglomeration or emulsifier-free swelling polymerization.

In the salt agglomeration process, dissolved salts bring about agglomeration of polymer particles and thus lead to particle enlargement.

Preference is given to combining emulsifier-free emulsion polymerization with salt agglomeration; the polymer particles are therefore prepared preferably by emulsifier-free emulsion polymerization and salt agglomeration.

The salt is preferably already dissolved in the water at the start of the emulsion polymerization, such that the agglomeration occurs actually at the start of the emulsion polymerization and the resulting agglomerated polymer particles then grow uniformly during the emulsion polymerization.

The salt concentration is preferably from 0.5 to 4% based on the polymer to be agglomerated, or from 0.05% to 0.5% based on the water or solvent used.

Useful salts include all water-soluble salts, for example the chlorides or sulfates of the alkali metals or alkaline earth metals.

The emulsifier-free emulsion polymerization can also be combined with a swelling polymerization. In the swelling polymerization, further monomers are added to an aqueous polymer dispersion which has already been obtained and has preferably been obtained by emulsifier-free emulsion polymerization (1st stage for short), and the polymerization of these monomers (2nd stage or swelling stage) is begun only after these monomers have diffused into the polymer particles already present and the polymer particles have swollen.

In the 1st stage, preferably from 5 to 50% by weight, more preferably from 10 to 30% by weight, of all monomers of which the polymer, i.e. the polymer particles, is/are composed are polymerized by emulsifier-free emulsion polymerization. The remaining monomers are polymerized in the swelling stage. The amount of the monomers of the swelling stage is a multiple of the amount of the monomer used in the first stage, preferably from two to ten times, more preferably from three to five times.

The swelling polymerization can also be effected without emulsifier and is preferably performed without emulsifier.

In particular, the monomers of the swelling stage are supplied only when the monomers of the 1st stage have polymerized to an extent of at least 80% by weight, in particular to an extent of at least 90% by weight.

A feature of the swelling polymerization is that the polymerization of the monomers is begun only after completion of swelling.

Therefore, during and after the addition of the monomers of the swelling stage, preference is given to not adding any initiator. When initiator is added or initiator is present in the polymerization vessel, the temperature is kept sufficiently low that no polymerization occurs. The polymerization of the monomers of the swelling stage is performed only after completion of swelling by adding the initiator and/or increasing the temperature. This may be the case, for example, after a period of at least half an hour after the addition of the monomers has ended. The monomers of the swelling stage are then polymerized, which leads to a stable particle enlargement.

The swelling polymerization can in particular also be undertaken in at least two stages (swelling stages), more preferably from 2 to 10 swelling stages. In each swelling stage, the monomers to be polymerized are fed, swollen and then polymerized; after polymerization of the monomers, the monomers of the next swelling stage are added and swollen with subsequent polymerization, etc. All monomers which are to be polymerized by swelling polymerization are preferably distributed uniformly between the swelling stages.

In a preferred embodiment, the polymer, i.e. the polymer particles, is/are crosslinked, for which a crosslinking monomer (crosslinker) is also used (see above). The crosslinker is preferably not added and polymerized until the swelling polymerization, more preferably in the last swelling stage.

In a particular embodiment, the polymer particles are therefore prepared by emulsifier-free emulsion polymerization, followed by swelling polymerization.

Particular preference is given to the combination of emulsifier-free emulsion polymerization with salt agglomeration, as described above, and a subsequent swelling polymerization.

The Production of the Photonic Crystals

For the production of photonic crystals, preference is given to using the aqueous polymer dispersions obtained in the above-described preparation processes.

For this purpose, the solids content of the aqueous polymer dispersions is preferably from 0.01 to 20% by weight, more preferably from 0.05 to 5% by weight, most preferably from 0.1 to 0.5% by weight. To this end, the polymer dispersions which have been prepared as described above and which are preferably synthesized with a solids content of from 30 to 50% are generally diluted with demineralized water.

The photonic crystals are preferably formed on a suitable support. Suitable supports include substrates of glass, of silicon, of natural or synthetic polymers, of metal or any other materials. The polymers should have very good adhesion on the support surface. The support surface is therefore preferably chemically or physically pretreated in order to obtain good wetting and good adhesion. The surface can be pretreated, for example, by corona discharge, coated with adhesion promoters or hydrophilized by treatment with an oxidizing agent, for example H2O2/H2SO4.

The temperature of the polymer dispersion and of the support in the formation of the photonic crystals is preferably in the range from 15 to 70° C., more preferably from 15 to 40° C., in particular room temperature (18 to 25° C.). The temperature is in particular below the melting point and below the glass transition point of the polymer.

The photonic crystals are prepared from the aqueous dispersion of the polymer particles preferably by volatilizing the water.

The support and the polymer dispersion are contacted.

The aqueous polymer dispersion can be coated onto the horizontal support, and the photonic crystal forms when the water volatilizes.

The support is preferably immersed at least partly into the diluted polymer dispersion. Evaporation of the water lowers the meniscus, and the photonic crystal forms on the formerly wetted parts of the support.

Surprisingly, at an angle between support and the liquid surface unequal to 90°, the crystalline order, especially in the case of particles above 600 nm, is significantly improved. At a crystallization angle of from 50° to 70°, the best crystalline order is achieved.

In a particular embodiment, support and polymer dispersion can be moved mechanically relative to one another, preferably with speeds of from 0.05 to 5 mm/hour, more preferably from 0.1 to 2 mm/hour. To this end, the immersed support can be pulled slowly out of the aqueous polymer dispersion and/or the polymer dispersion can be discharged from the vessel, for example by pumping.

The polymer particles are arranged in the photonic crystals in accordance with a lattice structure. The distances between the particles correspond to the mean particle diameters. The particle size (see above) and hence also the particle separation, based on the center of the particles, is preferably greater than 600 nm, preferentially greater than 1000 nm.

The order, i.e. lattice structure, forms in the aforementioned preparation. In particular, an fcc lattice structure (fcc=face-centered cubic) forms, with hexagonal symmetry in the crystal planes parallel to the surface of the support.

The photonic crystals obtainable in accordance with the invention have very high crystalline order; i.e. preferably below 10%, more preferably below 5%, most preferably below 2% of the surface of each crystal plane exhibits an orientation deviating from the rest of the crystal or no crystalline orientation at all, and there are barely any defects; in particular, the proportion of defects or deviation from order is therefore less than 2%, or 0%, based on the surface in question. The crystalline order can be determined microscopically, especially with atomic force microscopy. In this method, the uppermost layer of the photonic crystal is viewed; the above percentages regarding the maximum proportion of defect sites therefore apply especially for this uppermost layer. The interstices between the polymer particles are empty, i.e. they comprise air if anything.

The resulting photonic crystals preferably exhibit a decline in the transmission (stop band) at wavelengths greater than or equal to 1400 nm (at particle diameter 600 nm), more preferably greater than or equal to 2330 nm (at particle diameter 1000 nm).

According to the invention, it is possible to obtain photonic crystals whose regions of uniform crystalline order, in at least one three-dimensional direction, have a length of more than 100 μm, more preferably more than 200 μm, most preferably more than 500 μm.

The photonic crystals preferably have at least one length, more preferably both one length and one width, greater than 200 μm, in particular greater than 500 μm.

The thickness of the photonic crystals is preferably greater than 10 μm, more preferably greater than 30 μm.

The Use of the Photonic Crystals

The photonic crystal can be used as a template for producing an inverse photonic crystal. To this end, the cavities between the polymer particles, by known processes, are filled with the desired materials, for example with silicon, and then the polymer particles are removed, for example by melting and leaching-out or burning-out at high temperatures. The resulting template has the corresponding inverse lattice order of the former photonic crystal.

The photonic crystal or the inverse photonic crystal produced therefrom is suitable as an optical component. When defects are written into the inventive photonic crystal, for example with the aid of a laser or of a 2-photon laser arrangement or of a holographic laser arrangement, and the inverse photonic crystal is produced therefrom, both this modified photonic crystal and the corresponding inverse photonic crystals are useable as electronic optical components, for example as multiplexers or as optical semiconductors.

The photonic crystal, or the cavities of the colloid crystal, can be used for the infiltration of inorganic or organic substances.

### EXAMPLES

A) Preparation of the Polymers

### Comparative Example 1 with Charge on the Particle

A reactor with anchor stirrer, thermometer, gas inlet tube, charging tubes and reflux condenser was initially charged with 682.91 g of water. The flask contents were subsequently heated and stirred at a speed of 200 min⁻¹. During this time, nitrogen was fed to the reactor. On attainment of a temperature of 90° C., the nitrogen feed was stopped and air was prevented from getting into the reactor. Before the polymerization, 2% of a potassium peroxodisulfate solution composed of 2.05 g of potassium persulfate in 66.2 g of water and 8.7 g of styrene were fed to the reactor within 5 minutes and polymerization was then commenced for 15 minutes. The remaining potassium persulfate solution was then added within 6 hours. At the same time, monomer feed was metered in for 6 hours. After 2 hours 20 minutes of the monomer feed, a styrene-4-sulfonic acid (Na salt) solution consisting of 1.75 g of styrene-4-sulfonic acid (Na salt) and 68.25 g of water was started and metered in within 4 hours. Once the monomer addition had ended, the dispersion was allowed to continue to polymerize for 30 minutes. Subsequently, the mixture was cooled to room temperature.

The composition of the feeds was as follows:
Feed 1: monomer feed
348.25 g of styrene
Feed 2: initiator solution
68.25 g of potassium peroxodisulfate, concentration by mass 3% in water
Feed 3: auxiliary feed
70 g of styrene-4-sulfonic acid (Na salt), concentration by mass 2.5% in water

The resulting polymer particles had a weight-average particle size of 602 nm and a polydispersity index of 0.07.

### INVENTIVE EXAMPLES

### Example 1

### Emulsifier-free Emulsion Polymerization

A reactor with anchor stirrer, thermometer, gas inlet tube, charging tubes and reflux condenser was initially charged with 758.33 g of water. The flask contents were then heated and stirred at a speed of 200 min⁻¹. During this time, nitrogen was fed to the reactor. On attainment of a temperature of 85° C., the nitrogen feed was stopped and air was prevented from getting into the reactor. 10% of the monomer feed and 10% of a potassium peroxodisulfate solution composed of 3.5 g of sodium persulfate in 66.5 g of water were then fed to the reactor and preoxidized for 5 minutes, then the remaining sodium persulfate solution was added within 3 hours. At the same time, the remainder of the monomer feed was metered in for 3 hours.

The composition of the feeds was as follows:
Feed 1: monomer feed
350.00 g of styrene
Feed 2: initiator solution
70 g of sodium peroxodisulfate, concentration by mass 5% in water

The resulting polymer particles had a weight-average particle size of 624 nm (AUC) and a polydispersity index of 0.09.

### Example 2

### Emulsifier-free Emulsion Polymerization and Salt Agglomeration

A reactor with anchor stirrer, thermometer, gas inlet tube, charging tubes and reflux condenser was initially charged with 1279.20 g of water, 140.00 g of styrene and 2.80 g of sodium chloride. The flask contents were subsequently heated and stirred at a speed of 225 min⁻¹. During this time, nitrogen was fed to the reactor. On attainment of a temperature of 75° C., the nitrogen feed was stopped and air was prevented from getting into the reactor. A sodium peroxodisulfate solution composed of 1.4 g of sodium persulfate in 18.6 g of water was then fed to the reactor and oxidized for 24 hours. Subsequently, the mixture was cooled to room temperature.

The composition of the feeds was as follows:

### Initial Charge:

1279.20 g of water
140.00 g of styrene
2.80 g of sodium chloride
Feed 1: initiator solution
20 g of sodium peroxodisulfate, concentration by mass 7% in water

The resulting polymer particles had a weight-average particle size of 1039 nm and a polydispersity index of 0.09.

### Example 3

### Emulsifier-free Emulsion Polymerization and Swelling Polymerization

A reactor with anchor stirrer, thermometer, gas inlet tube, charging tubes and reflux condenser was initially charged with 764.47 g of water. The flask contents were subsequently heated and stirred at a speed of 200 min⁻¹. During this time, nitrogen was fed to the reactor. On attainment of a temperature of 85° C., the nitrogen feed was stopped and air was prevented from getting into the reactor. 10% of the monomer feed and 10% of potassium peroxodisulfate solution composed of 1.74 g of potassium persulfate in 56.26 g of water were then fed to the reactor and preoxidized for 5 minutes, then the remaining potassium persulfate solution was added within 3 hours. At the same time, the remainder of the monomer feed was metered in for 3 hours.

282.69 g of this dispersion were initially charged in a reactor with anchor stirrer, thermometer, gas inlet tube, charging tubes and reflux condenser, as were 927.01 g of water, 1.07 g of Texapon NSO (28% in water) and 120 g of styrene. The flask contents were subsequently heated and stirred at a speed of 150 min⁻¹. During this time, nitrogen was fed to the reactor. On attainment of a temperature of 75° C., the nitrogen feed was stopped and air was prevented from getting into the reactor. A sodium peroxodisulfate solution composed of 0.6 g of sodium persulfate in 7.97 g of water was then fed to the reactor and polymerized to completion.

In turn, 642.86 g of this dispersion were initially charged in a reactor with anchor stirrer, thermometer, gas inlet tube, charging tubes and reflux condenser, as were 462.70 g of water, 0.8 g of Texapon NSO (28% in water) and 90 g of styrene. The flask contents were subsequently heated and stirred at a speed of 150 min⁻¹. During this time, nitrogen was fed to the reactor. On attainment of a temperature of 75° C., the nitrogen feed was stopped and air was prevented from getting into the reactor. A sodium peroxodisulfate solution composed of 0.67 g of sodium persulfate in 8.97 g of water was then fed to the reactor and polymerized to completion.

The composition of the feeds was as follows:

### 1st Stage:

Feed 1: monomer feed
350.00 g of styrene
Feed 2: initiator solution
58 g of potassium peroxodisulfate, concentration by mass 3% in water

### 2nd Stage:

### Initial Charge:

927.01 g of water
282.69 g of seed (polystyrene particles from 1st stage), concentration by mass:
28.3% in water
1.07 g of Texapon NSO, concentration by mass: 28% in water
120.00 g of styrene
Feed 1: initiator solution
8.57 g of sodium peroxodisulfate, concentration by mass 7% in water

### 3rd Stage:

### Initial Charge:

462.70 g of water
642.86 g of seed (polystyrene particles from 2nd stage), concentration by mass: 14% in water
0.80 g of Texapon NSO, concentration by mass: 28% in water
90.00 g of styrene
Feed 1: initiator solution
9.64 g of sodium peroxodisulfate, concentration by mass 7% in water

The resulting polymer particles had a weight-average particle size of 963 nm and a polydispersity index of 0.06.

### Example 4

### Emulsifier-free Emulsion Polymerization with Salt Agglomeration and Swelling Polymerization

A reactor with anchor stirrer, thermometer, gas inlet tube, charging tubes and reflux condenser was initially charged with 1260.90 g of water, 140.00 g of styrene and 0.77 g of sodium chloride. The flask contents were subsequently heated and stirred at a speed of 225 min⁻¹. During this time, nitrogen was fed to the reactor. On attainment of a temperature of 75° C., the nitrogen feed was stopped and air was prevented from getting into the reactor. A sodium peroxodisulfate solution composed of 1.4 g of sodium persulfate in 18.6 g of water was then fed to the reactor and oxidized for 24 hours. Subsequently, the mixture was cooled to room temperature.

599.25 g of this dispersion were initially charged in a reactor with anchor stirrer, thermometer, gas inlet tube, charging tubes and reflux condenser, as were 653.65 g of water and 80 g of styrene. The flask contents were subsequently heated and stirred at a speed of 150 min⁻¹. During this time, nitrogen was fed to the reactor. On attainment of a temperature of 75° C., the nitrogen feed was stopped and air was prevented from getting into the reactor. A sodium peroxodisulfate solution composed of 0.4 g of sodium persulfate in 5.31 g of water was then fed to the reactor and polymerized to completion. Subsequently, the mixture was cooled to room temperature.

In turn, 659.34 g of this dispersion were initially charged in a reactor with anchor stirrer, thermometer, gas inlet tube, charging tubes and reflux condenser, as were 479.70 g of water and 60 g of styrene. The flask contents were subsequently heated and stirred at a speed of 150 min⁻¹. During this time, nitrogen was fed to the reactor. On attainment of a temperature of 75° C., the nitrogen feed was stopped and air was prevented from getting into the reactor. A sodium peroxodisulfate solution composed of 0.45 g of sodium persulfate in 5.98 g of water was then fed to the reactor and polymerized to completion.

The composition of the feeds was as follows:

### 1st Stage

### Initial Charge:

1279.20 g of water
140.00 g of styrene
2.80 g of sodium chloride
Feed 1: initiator solution
20 g of sodium peroxodisulfate, concentration by mass 7% in water

### 2nd Stage:

### Initial Charge:

653.65 g of water
599.25 g of seed (polystyrene particles from 1st stage), concentration by mass: 28.3% in water
80.00 g of styrene
Feed 1: initiator solution
5.71 g of sodium peroxodisulfate, concentration by mass 7% in water

### 3rd Stage:

### Initial Charge:

479.70 g of water
659.34 g of seed (polystyrene particles from 2nd stage), concentration by mass: 14% in water
60.00 g of styrene
Feed 1: initiator solution
6.43 g of sodium peroxodisulfate, concentration by mass 7% in water

The resulting polymer particles had a weight-average particle size of 967 nm and a polydispersity index of 0.08.

### Example 5

### Emulsifier-free Emulsion Polymerization and Swelling Polymerization with Crosslinker in the Last Stage

A reactor with anchor stirrer, thermometer, gas inlet tube, charging tubes and reflux condenser was initially charged with 764.47 g of water. The flask contents were subsequently heated and stirred at a speed of 200 min⁻¹. During this time, nitrogen was fed to the reactor. On attainment of a temperature of 85° C., the nitrogen feed was stopped and air was prevented from getting into the reactor. 10% of the monomer feed and 10% of a potassium peroxodisulfate solution composed of 1.74 g of potassium persulfate in 56.26 g of water were then fed to the reactor and preoxidized for 5 minutes, then the remaining potassium persulfate solution was added within 3 hours. At the same time, the remainder of the monomer feed was metered in for 3 hours.

282.69 g of this dispersion were initially charged in a reactor with anchor stirrer, thermometer, gas inlet tube, charging tubes and reflux condenser, as were 927.01 g of water, 1.07 g of Texapon NSO (28% in water) and 120 g of styrene. The flask contents were subsequently heated and stirred at a speed of 150 min⁻¹. During this time, nitrogen was fed to the reactor. On attainment of a temperature of 75° C., the nitrogen feed was stopped and air was prevented from getting into the reactor. A sodium peroxodisulfate solution composed of 0.6 g of sodium persulfate in 7.97 g of water was then fed to the reactor and polymerized to completion.

In turn, 642.86 g of this dispersion were initially charged in a reactor with anchor stirrer, thermometer, gas inlet tube, charging tubes and reflux condenser, as were 462.70 g of water, 0.8 g of Texapon NSO (28% in water) and 90 g of styrene with 3.6 g of divinylbenzene. The flask contents were subsequently heated and stirred at a speed of 150 min⁻¹. During this time, nitrogen was fed to the reactor. On attainment of a temperature of 75° C., the nitrogen feed was stopped and air was prevented from getting into the reactor. A sodium peroxodisulfate solution composed of 0.67 g of sodium persulfate in 8.97 g of water was then fed to the reactor and polymerized to completion.

The composition of the feeds was as follows:

### 1st Stage:

Feed 1: monomer feed
350.00 g of styrene
Feed 2: initiator solution
58 g of potassium peroxodisulfate, concentration by mass 3% in water

### 2nd Stage:

### Initial Charge:

927.01 g of water
282.69 g of seed (polystyrene particles from 1st stage), concentration by mass: 28.3% in water
1.07 g of Texapon NSO, concentration by mass: 28% in water
120.00 g of styrene
Feed 1: initiator solution
8.57 g of sodium peroxodisulfate, concentration by mass 7% in water 3rd stage:

### Initial Charge:

462.70 g of water
642.86 g of seed (polystyrene particles from 2nd stage), concentration by mass: 14% in water
0.80 g of Texapon NSO, concentration by mass: 28% in water
90.00 g of styrene
3.6 g of divinylbenzene
Feed 1: initiator solution
9.64 g of sodium peroxodisulfate, concentration by mass 7% in water

The resulting polymer particles had a weight-average particle size of 1008 nm and a polydispersity index of 0.06.

The photonic crystals produced with them were stable even above the glass transition temperature of the polymer, i.e. coalescence of the polymer particles was prevented. On the other hand, the mechanical stability of the photonic crystal was increased specifically as a result of the heat treatment above the glass transition temperature, which was surprisingly found to be particularly advantageous in the writing of defect structures into the photonic crystal with the aid of a laser and in the further use as a template for the production of the inverse photonic crystal.

B) Production of the Photonic Crystals

### Example 6

### Vertical Deposition on Non-vertical Substrate by Evaporation at Room Temperature

A 3×8 cm glass microscope slide was cleaned overnight and hydrophilized with Caro's acid (H2O2:H2SO4 in a ratio of 3:7). The microscope slide was then held in a beaker at a 60° angle to the horizontal. The emulsifier-free polymer dispersion according to Example 1 was diluted to a concentration by mass of 0.3% with demineralized water and introduced into the beaker until it partly covered the microscope slide. In a heated cabinet at 23° C., half of the water was evaporated, then the microscope slide was removed and dried completely.

The photonic crystal thus produced was imaged with atomic force microscopy (AFM, Asylum MFP3D) and has regions of uniform crystalline fcc order in the plane of the surface of the slide.

When a laser beam of wavelength 488 nm (as described in García-Santamaría et al., PHYSICAL REVIEW B 71 (2005) 195112) with a diameter of 1 mm is directed onto the sample at right angles, the diffraction pattern exhibits a uniform hexagonal point symmetry without addition of other components. This laser diffraction analysis demonstrates the uniform crystalline order over the surface irradiated, i.e. at least 500 μm×500 μm.

The thickness of the photonic crystal on the slide was determined to be 40 μm. In the IR transmission, a stop band at 1400 nm with an optical density of 1.7 is found, which is likewise detected in the IR reflection.

1. A method for producing photonic crystals comprising contacting a support with an aqueous dispersion of polymer particles; and volatilizing the water, wherein
the polymer particles have a weight-average particle size of greater than 600 nm and a content of ionic groups of less than 0.001 mol, mol/1 g of polymer particles, and
the polymer particles form the lattice structure of the photonic crystal without being embedded into a liquid or solid matrix.

2. The method according to claim 1, wherein the polymer particles have a weight-average particle size greater than 1000 nm.

3. The method according to claim 1, wherein the polydispersity index, as a measure of the uniformity of the polymer particles, is less than 0.15, where the polydispersity index is calculated by the formula
P.I.=(D90−D10)/D50
in which D90, D10 and D50 denote particle diameters for which:
D90: 90% by weight of the total mass of all particles has a particle diameter of less than or equal to D90
D50: 50% by weight of the total mass of all particles has a particle diameter of less than or equal to D50
D10: 10% by weight of the total mass of all particles has a particle diameter of less than or equal to D10.

4. The method according to claim 1, wherein the polydispersity index, as a measure of the uniformity of the polymer particles, is less than 0.10.

5. The method according to claim 1, wherein no surface-active assistants which are used to disperse polymer particles in water are present on the surface of the polymer particles.

6. The method according to claim 1, wherein the polymer particles comprise monomer units that are present in uncharged form in the polymer particle.

7. The method according to claim 1, wherein the polymer particles comprise hydrocarbon monomer units to an extent of more than 90% by weight.

8. The method according to claim 1, wherein the polymer particles comprise styrene units to an extent of more than 90% by weight.

9. The method according to claim 1, wherein the polymer particles comprise crosslinking monomer units to an extent of from 0.01% by weight to 10% by weight.

10. The method according to claim 1, wherein the crosslinking monomer unit is divinylbenzene.

11. The method according to claim 1, wherein the polymer particles have a glass transition temperature above 50° C.

12. The method according to claim 1, wherein the polymer particles are prepared by emulsifier-free emulsion polymerization.

13. The method according to claim 1, wherein the polymer particles are prepared by emulsifier-free emulsion polymerization and salt agglomeration.

14. The method according to claim 1, wherein the polymer particles are prepared by emulsifier-free emulsion polymerization and swelling polymerization.

15. The method according to claim 1, wherein the polymer particles are prepared by emulsifier-free emulsion polymerization, salt agglomeration and swelling polymerization.

16. The method according to claim 14, wherein the swelling polymerization is also emulsifier-free.

17. The method according to claim 14, wherein the swelling polymerization is undertaken in at least two stages.

18. The method according to claim 17, wherein the polymer, is crosslinked and the crosslinker is added in the last swelling stage in the preparation.

19. A photonic crystal obtainable by the method according to claim 1.

20. The photonic crystal according to claim 19 with a particle separation, based on the center of the particles, greater than 600 nm.

21. The photonic crystal according to claim 19 with at least one edge length greater than 200 μm.

22. (canceled)

23. The A method for producing templates comprising filling cavities present in the photonic crystal according to claim 19 with a material; and removing said polymer particles.

24. The A method for producing templates with defined defect structures comprising writing defects into the photonic crystal according to claim 19, filling cavities present in the photonic crystal with a material; and removing said polymer particles.

25. (canceled)

26. Polymer particles for producing photonic crystals, which have a weight-average particle size of greater than 600 nm, a content of ionic groups of less than 0.001 mol/1 g of polymer particles, and a polydispersity index, as a measure of the uniformity of the polymer particles, of less than 0.15, where the polydispersity index is calculated by the formula
P.I.=(D90−D10)/D50
in which D90, D10 and D50 denote particle diameters for which:
D90: 90% by weight of the total mass of all particles has a particle diameter of less than or equal to D90
D50: 50% by weight of the total mass of all particles has a particle diameter of less than or equal to D50
D10: 10% by weight of the total mass of all particles has a particle diameter of less than or equal to D10.

27. The polymer particles according to claim 26, having a content of ionic groups of less than 0.0001 mol/1 g of polymer particles.

28. The photonic crystal according to claim 19 with a particle separation, based on the center of the particles, greater than 1000 nm.

29. The photonic crystal according to claim 19 with at least one edge length greater than 500 μm.

30. The method according to claim 1, wherein the polymer particles have a glass transition temperature above 80° C.

31. The method according to claim 1, wherein the polymer particles comprise crosslinking monomer units to an extent of from 0.1% by weight to 3% by weight.

32. The method according to claim 1, wherein the polymer particles consist of monomer units that are present in uncharged form in the polymer particle.

33. The method according to claim 1, wherein the polymer particles consist of hydrocarbon monomer units to an extent of more than 90% by weight.

34. The method according to claim 1, wherein the polymer particles consist of styrene units to an extent of more than 90% by weight.

35. The method according to claim 1, having a content of ionic groups of less than 0.0001 mol/1 g of polymer particles.
